(19) United States
(12) Patent Application Publication
(10) Pub. No.: US 2026/0169018 A1
(43) Pub. Date: Jun. 18, 2026

(54) AUTOMATIC ANALYSIS DEVICE AND STEP-FLOW AUTOMATIC ANALYSIS METHOD

(71) Applicant: National Taiwan University, Taipei City (TW)

(72) Inventor: Su-Cheng PAI, Taipei City (TW)

(21) Appl. No.: 19/093,626

(22) Filed: Mar. 28, 2025

(30) Foreign Application Priority Data
Dec. 18, 2024 (TW) 113149432

(51) Int. Cl. G01N 35/10; G01N 35/00; G01N 35/08

(52) U.S. Cl. CPC G01N 35/1095; G01N 35/0092; G01N 35/08; G01N 2035/00346

(57) ABSTRACT

An automatic analysis device for measuring chemical substances in water includes a main pipe, an air pipe connected to the main pipe, an air pump connected to the air pipe, a detector connected to an end of the main pipe opposite the air pipe, a sample-drawing pipe connected to the main pipe, a sample-drawing pump connected to the sample-drawing pipe, a flushing pipe connected to the main pipe, a flushing pump connected to the flushing pipe, a reagent pipe connected to the main pipe, a reagent pump connected to the reagent pipe, and an electric relay module signally communicated to the sample-drawing pump, the reagent pump, the air pump, and the flushing pump. A step-flow automatic analysis method is also disclosed.

### CROSS-REFERENCE TO RELATED APPLICATION

This application claims priority to Taiwanese Invention Patent Application No. 113149432, filed on Dec. 18, 2024, and incorporated by reference herein in its entirety.

### FIELD

The present disclosure relates to the field of automatic analysis for measuring chemical substances in water, and more particularly to an automatic analysis device and a step-flow automatic analysis method. The automatic analysis device features an automatic sample-drawing function and an automatic pipeline washing, both controlled by electric relay modules, and operates in a step-by-step manner.

### BACKGROUND

Spectrophotometry is an important method for measuring chemical substances in water in traditional analytical chemistry. However, when faced with a large number of sample groups, analysts must repeat the same process multiple times, which is both time-consuming and labor-intensive. As a result, those skilled in the art have dedicated significant research and development efforts to the advancement of technologies related to automatic analysis.

A commonly used technology is the flow injection analyzer (FIA) which utilizes a multi-channel peristaltic pump to control the flow rate of liquid in each pipe simultaneously at a fixed rotational speed. The flow injection analyzer uses an injector to introduce a fixed volume of sample (or item to be tested) into a flowing carrier fluid. The carrier flow is then merged with a reagent flow, resulting in a chemical reaction within the mixed liquid flow. As the mixed liquid flow passes through a detector, such as a spectrophotometer, an absorbance signal is obtained and compared with the sample's standard (or item to be tested) to calculate the concentration of the substance in the sample.

However, the flow injection analyzer has the following disadvantages:
1. The sample is diluted by the carrier fluid, leading to a reduction in the concentration of the substance to be measured.
2. When the mixed liquid flow passes through the detector, the chemical reaction may not be fully completed, causing the detector to only capture a maximum absorbance peak value.
3. For two consecutive sample sections, a large carrier flow section must be inserted between them, which increases the analysis time.
4. No bubbles should be present in the pipeline, as they can cause noise or misjudgment.

Improving the performance of the analyzer to effectively enhance the analysis efficiency remains one of the primary goals for researchers in the relevant field.

### SUMMARY

Therefore, an object of the present disclosure is to provide an automatic analysis device for measuring chemical substances in water that can alleviate the drawbacks outlined above in the prior art.

According to this disclosure, the automatic analysis device for measuring chemical substances in water includes a main pipe, a sample-drawing unit, a reagent unit, an air push unit, a heating unit for heating the main pipe, a detection unit, a flushing unit, and an electric relay module.

The sample-drawing unit includes a sample-drawing pipe, a sample-drawing pump, and a sample water container. One end of the sample-drawing pipe is connected to the main pipe, while the other end is connected to the sample water container. The sample-drawing pipe and the main pipe are positioned between the detector and the air pipe. The sample-drawing pump is connected to the sample-drawing pipe, and is configured to draw sample water from the sample water container and push it into the main pipe through the sample-drawing pipe.

The air push unit includes an air pipe and an air pump. One end of the air pipe is connected to the main pipe, while the other end is connected to the air pump. The air pump is configured to draw and push air into the main pipe through the air pipe.

The reagent unit includes a reagent pipe, a reagent pump, and a reagent container. One end of the reagent pipe is connected to the main pipe, while the other end is connected to the reagent container. The reagent pipe is positioned between the main pipe and the detector. The reagent pump is connected to the reagent pipe, and is configured to draw and push a reagent solution from the reagent container into the main pipe through the reagent pipe.

The detection unit includes a detector connected to an end of the main pipe opposite the air pipe.

The flushing unit includes a flushing pipe, a flushing pump, and a flushing liquid container. One end of the flushing pipe is connected to the main pipe, while the other end is connected to the flushing liquid container. The flushing pipe is positioned between the main pipe and the sample-drawing pipe. The flushing pump is connected to the flushing pipe, and is configured to draw flushing liquid from the flushing liquid container and push it into the main pipe through the flushing pipe.

The electric relay module is electrically communicated to the sample-drawing pump, the reagent pump, the air pump, and the flushing pump.

Instead of using a multi-channel peristaltic pump, all pumps used in this disclosure are single-channel micro peristaltic pumps. The “pipe” referenced in this disclosure refer to ‘flexible micro-bore polytetrafluoroethylene tubing’ with an internal diameter of 0.5 to 2.0 mm.

Another object of the present disclosure is to provide a step-flow automatic analysis method for measuring chemical substances in water. According to this disclosure, the step-flow automatic analysis method includes:
a sample drawing and delivery step, in which the sample-drawing pump and the reagent pump are simultaneously activated through the electric relay module to draw the sample water from the sample water container and push the reagent solution from the reagent container through the main pipe to the detection unit for analysis;
a sample return step, in which, before the sample-drawing pump and the reagent pump are stopped at a time denoted as t1, which is equal to or less than two seconds, the air pump is activated to draw and push air into the main pipe, and a flow rate of the air is controlled to match a flow rate of the sample-drawing pump; and in which, after the sample-drawing pump and the reagent pump are turned off at a time denoted as t2, which is equal to or less than two seconds, the air continues to be pushed, and at this point, the air no longer enters the main pipe, but pushes any remaining sample water in the sample-drawing pipe back into the sample water container, after which the air pump is turned off; and
a flushing step, in which the flushing pump is activated to allow the flushing liquid to remove the sample water from the main pipe and the detector.

### BRIEF DESCRIPTION OF THE DRAWINGS

Other features and advantages of the disclosure will become apparent in the following detailed description of the embodiment with reference to the accompanying drawings. It should be noted that various features may not be drawn to scale.

FIG. 1 is a schematic diagram of an automatic analysis device according to one embodiment of the present disclosure.

FIG. 2 is a time versus absorbance value graph, illustrating actual detection data of three consecutive detections using a step-flow automatic analysis method of this disclosure.

### DETAILED DESCRIPTION

A step-flow automatic analysis method according to an embodiment of the present disclosure is used to measure chemical substances in water, and is implemented using an automatic analysis device described hereinafter.

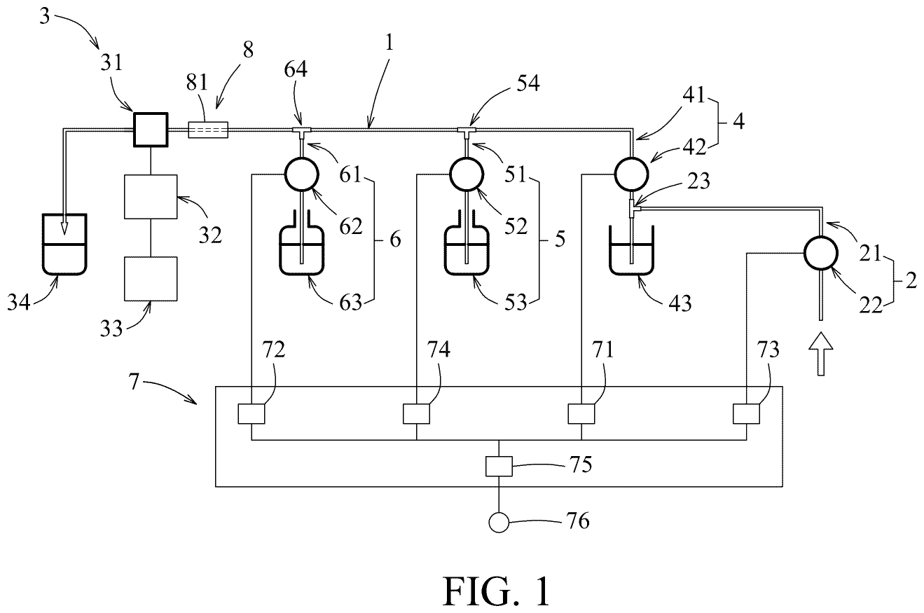

Referring to FIG. 1, the automatic analysis device according to an embodiment of the present disclosure comprises a main pipe 1, an air push unit 2, a detection unit 3, a sample-drawing unit 4, a flushing unit 5, a reagent unit 6, an electric relay module 7, and a heating unit 8.

The air push unit 2 comprises an air pipe 21, an air pump 22, and a three-way connector 23. One end of the air pipe 21 is connected to the main pipe 1 via the three-way connector 23 and the sample-drawing unit 4, while the other end is connected to the air pump 22. The air pump 22 is configured to draw and push air into the main pipe 1 through the air pipe 21.

The detection unit 3 comprises a detector 31 connected to an end of the main pipe 1 opposite the air pipe 21, a signal transmission module 32 electrically communicated to the detector 31, and a processor 33 communicated to the signal transmission module 32. Liquid entering the detector 31 can be directed to a waste liquid tank 34. The signal transmission module 32 is an RS-232 signal output module. The detector 31 is a spectrophotometer, and includes a flow cuvette (not shown) for holding and storing liquid.

An optical path of the flow cuvette ranges from 1 to 5 cm. The detector 31 can read the absorbance value of the sample water in the flow cuvette at a specified wavelength, and transmit the absorbance value signal to the processor 33 via the signal transmission module 32. The processor 33 can then obtain a corresponding detection signal based on a detection result.

The sample-drawing unit 4 comprises a sample-drawing pipe 41, a sample-drawing pump 42, and a sample water container 43. One end of the sample-drawing pipe 41 is connected to the main pipe 1, while the other end is connected to the sample water container 43. The sample-drawing pipe 41 and the main pipe 1 are positioned between the detector 31 and the air pipe 21. The sample-drawing pump 42 is connected to the sample-drawing pipe 41, and is configured to draw and push sample water from the sample water container 43 into the main pipe 1 through the sample-drawing pipe 41. If the sample water in the sample water container 43 is distilled water, the absorbance value measured by the detector 31 corresponds to a reagent blank value.

The flushing unit 5 comprises a flushing pipe 51, a flushing pump 52, a flushing liquid container 53, and a three-way connector 54. One end of the flushing pipe 51 is connected to the main pipe 1 through the three-way connector 54, while the other end is connected to the flushing liquid container 53. The flushing pipe 51 is positioned between the main pipe 1 and the sample-drawing pipe 41. The flushing pump 52 is connected to the flushing pipe 51, and is configured to draw and push flushing liquid from the flushing liquid container 53 into the main pipe 1 through the flushing pipe 51.

The reagent unit 6 comprises a reagent pipe 61, a reagent pump 62, a reagent container 63, and a three-way connector 64. One end of the reagent pipe 61 is connected to the main pipe 1 through the three-way connector 64, while the other end is connected to the reagent container 63. The reagent pipe 61 is positioned between the main pipe 1 and the detector 31. The reagent pump 62 is connected to the reagent pipe 61, and is configured to draw and push a reagent solution from the reagent container 63 into the main pipe 1 through the reagent pipe 61. The reagent solution is selected based on the elements to be detected in the sample water. Since the sample water and corresponding reagent solution are matched according to specific requirements, and this is not the focus of the present disclosure, a detailed description is omitted herein.

Moreover, when multiple reagent solutions are required for detecting different elements in the sample water, a plurality of the reagent units 6 may be provided between the main pipe 1 and the detector 31. Specifically, the three-way connectors 64 of the reagent units 6 are spaced along the main pipe 1, with each reagent pump 62 connected to its respective reagent pipe 61. The reagent pipes 61 are each connected to a reagent container 63, and are connected to the main pipe 1 through their respective three-way connectors 64. This configuration allows for the simultaneous drawing of multiple reagent solutions into the main pipe 1.

It should be noted that each of the main pipe 1, the air pipe 21, the sample-drawing pipe 41, the flushing pipe 51, and the reagent pipe 61 may be made of polytetrafluoroethylene or other acid-and alkali-resistant materials. The material of pumping tubes in each of the air pump 22, the sample-drawing pump 42, the flushing pump 52, and the reagent pump 62 may be silicone or acid-and alkali-resistant biopharmaceutical tubing (BPT). Each of the three-way connectors 23, 54 and 64 is made of polytetrafluoroethylene or polypropylene.

The heating unit 8 is positioned on the main pipe 1 upstream of the detector 31 and includes a heater 81 that surrounds a portion of the coiled main pipe 1 adjacent to the detector 31. The heater 81 is configured to heat the main pipe 1, thereby enhancing the mixing between the sample water and the reagent solution and increasing the rate of chemical reaction.

Each of the air pump 22, the sample-drawing pump 42, the reagent pump 62, and the flushing pump 52 may be selected from commercially available DC micro peristaltic pumps, but is not limited to such. In this embodiment, the pumping tube of the reagent pump 62 is a biopharmaceutical tube manufactured by Saint-Gobain, a French company, with an inner diameter of 0.8 mm. The pumping tubes of the air pump 22 and the sample-drawing pump 42 are silicon tubes with an inner diameter of 2 mm, and the pumping tube of the flushing pump 52 is a silicon tube with an inner diameter of 3 mm.

The electric relay module 7 includes an actuation button 76, a main relay 75, and four relays 71, 72, 73, 74. The sample-drawing relay 71 is signal-communicated to the sample-drawing pump 42, a reagent relay 72 is signal-communicated to the reagent pump 62, the air relay 73 is signal-communicated to the air pump 22, and the flushing relay 74 is signal-communicated to the flushing pump 52. These relays control the turning on or off of the corresponding pumps through a preset program. The actuation button 76 is operated to send a trigger signal to the main relay 75, which then sends trigger signals to the four other relays 71, 72, 73 and 74. The main relay 75 can be set to activate once or multiple times for one measurement or multiple measurements.

For example, for one measurement, an operating time of the sample-drawing pump 42, controlled by the sample-drawing relay 71, can be set from 0 to 10 seconds; an operating time of the reagent pump 62, controlled by the reagent relay 72, can be set from 0 to 10 seconds; an operating time of the air pump 22, controlled by the air relay 73, can be set from 9 to 11 seconds; and an operating time of the flushing pump 52, controlled by the flushing relay 74, can be set from 90 to 100 seconds. These time settings are just an example, and a user may adjust them according to the requirements.

Specifically, the step-flow automatic analysis method of this embodiment includes a sample drawing and delivery step, a sample return step, a stop-and-detection step, and a flushing step.

Before starting the step-flow automatic analysis method of this disclosure, a detection wavelength of the detector 31 is first adjusted, after which distilled water is filled into the sample container 43. The first measurement is carried out by pressing the actuation button 76. After 100 seconds, the flow cuvette in the detector 31 is filled with flushing liquid, and the absorbance value is reset to zero. The system is now ready to use.

In the sample drawing and delivery step, the actuation button 76 of the electric relay module 7 sends a trigger signal to the main relay 75, which then simultaneously turns on the sample-drawing pump 42 and the reagent pump 62. As a result, the sample-drawing pump 42 draws and pushes the sample water from the sample water container 43 to the main pipe 1 through the sample-drawing pipe 41, and the reagent pump 62 draws and pushes the reagent solution from the reagent container 63 to the main pipe 1 through the reagent pipe 61. The reagent solution converges with the sample water at the three-way connector 64, where the sample water mixes with the reagent solution. The mixture of the sample water and the reagent solution is then pushed to the detector 31, completely filling the flow cuvette.

Specifically, in the sample drawing and delivery step, the sample-drawing pump 42 and the reagent pump 62 are operated for a period of 0 to 10 seconds, while the air pump 22 operates from 9 to 11 seconds. Before the sample-drawing pump 42 and the reagent pump 62 stop, a portion of air (from 9 to 10 seconds) is pushed by the air pump 22 and enters the main pipe 1 through the air pipe 21, the three-way connector 23, and the sample-drawing pump 42. Hence, the time for sending the sample water to the main pipe 1 in the sample drawing and delivery step is actually from 0 to 9 seconds.

The sample return step is performed after the sample drawing and delivery step is completed from 0 to 10 seconds. Since the air pump 22 continues to operate from 10 to 11 seconds, air does not enter the main pipe 1 but instead flows through the air pipe 21 and the three-way connector 23 to push the remaining sample water in the sample-drawing pipe 41 back to the sample water container 43, thereby completing the sample return step.

The time for air injection and sample return may be adjusted. Specifically, the air pump 22 can be started at t1 time and stopped at t2 time after the sample-drawing pump 42 is stopped. In the above example, the operation time for the air pump 22 is from 10−t1 to 10+t2 seconds.

The stop-and-detection step is performed after the sample return step is completed. In this step, all the pumps (i.e., the air pump 22, the sample-drawing pump 42, the flushing pump 52, and the reagent pump 62) of the automatic analysis device are turned off or stopped from operating to retain the mixture of the sample water and the reagent solution in the detector 31 for a stop time, allowing a more complete chemical reaction for detection. For example, in this embodiment, the stop time is set from 11 to 90 seconds, during which all the pumps are stopped from operating. However, in actual implementation, the stop time may be adjusted according to the different measurement items. When the stop time ends, the signal obtained by the detector 31 is transmitted to the processor 33 through the signal transmission module 32. At this time, the absorbance value gradually increases toward a stable value, and this value is recorded by the data processor 33.

The flushing step is performed after the stop-and-detection step is completed. In this step, the flushing pump 52 is activated by the flushing relay 74, and an operating time of the flushing pump 52 in this embodiment is set from 90 to 100 seconds. During this time, the flushing liquid in the flushing liquid container 53 is drawn by the flushing pump 52 to flow through the flushing pipe 51 and the three-way connector 54 into the main pipe 1. From the main pipe 1, the flushing liquid is continuously pushed toward the waste liquid tank 34 located downstream of the detector 31. The flushing liquid in this embodiment is deionized or distilled water, but it is not limited to these options.

It should be noted that the flow rate of the flushing pump 52 is relatively high such that the flushing liquid can reach the waste liquid tank 34 within 5 seconds. All the residual sample water and reagent solution remaining in the main pipe 1, from the three-way connector 54 to the waste liquid tank 34, can be completely removed after 10 seconds of flushing, thereby resetting the absorbance value of the detector 31 to zero. At the 100th second, all the pumps are stopped, thereby completing a one-time measurement. The automatic analysis device will return to a standby state and wait for the next measuring cycle.

Specifically, the above-mentioned five operation steps are executed automatically by a preset program stored in the relays 75, 71, 72, 73, 74. After the measurement, since the flushing flow rate is very high, the flushing volume is large, and the flushing time is very short, there will be no remnants of the reagent solution or the sample water left in the main pipe 1, thereby effectively preventing interference of detection signals between two different analyses.

In the flushing step, an air section exists in the main pipe 1 between the three-way connector 54 and the three-way connector 64. When this air section passes through the detector 31, a spike value is generated. Moreover, for the next measurement, an air section exists from the sample water container 43 to the three-way connector 54. When this air section passes through the detector 31, another spike is generated. These spike values usually last only 1 to 2 seconds and can be filtered out by the processor 33.

Since bubble spike interferences occur only when the liquid in the detector 31 or the main pipe 1 is flowing, it is set that only when all the pumps are stopped from operating will the signal transmitted be the effective absorbance value. In this embodiment, after the actuation button 76 is pressed, the signals from 0 to 10 seconds and from 90 to 100 seconds are omitted.

This disclosure uses the electric relay module 7 to control all the pumps to achieve automatic drawing of the sample and the reagent, sample returning, liquid mixing in the main pipe 1, and delivery to the detector 31, followed by waiting for the complete chemical reaction, detecting and recording the data, and quickly flushing the entire tubular pipeline. All of these steps are performed in sequence; therefore, it is called the step-flow automatic analysis method.

The traditional automatic analysis method (e.g., flow injection analysis) requires the use of an expensive multi-channel peristaltic pump, continuous operation with a continuous carrier flow, an injector, and must prevent air bubbles from entering the pipeline. The detection signal is obtained when the liquid is flowing. In contrast, the present disclosure does not require a carrier flow or an injection valve, does not need to run continuously, but achieves much more stable results with better sensitivity (because detection occurs when the flow stops and the chemical reaction is nearly complete). Therefore, this disclosure has the advantages of being cost-effective, using less reagent, easy to operate and maintain, while achieving more accurate and reliable results.

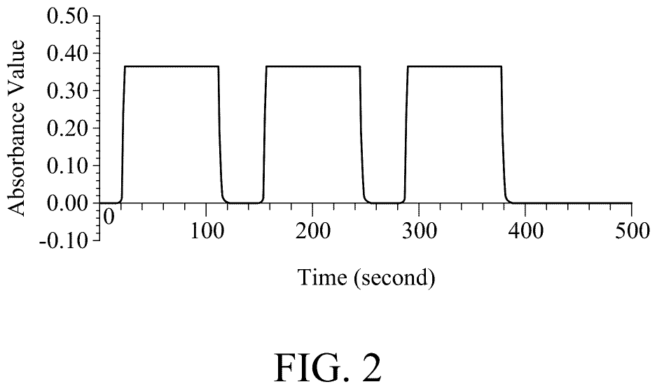

FIG. 2 shows actual detection data from three consecutive measurements of a dye solution using the automatic analysis device of this disclosure and the embodiment of the step-flow automatic analysis method. The operation starts at the 16th second. A front section of the sample water reaches the detector 31 at the 21st second, and the absorbance signal begins to rise quickly. The sample drawing is stopped at the 26th second. At this time, the absorbance value becomes stable, and all the pumps stop operating from the 27th second to the 106th second. The flushing step occurs between the 106th second and 116th second, and the absorbance drops quickly to zero. Afterwards, the aforementioned step-flow automatic analysis method is performed two more times. This diagram demonstrates the drawing and flushing efficiency, stability, and reproducibility of the present disclosure.

In summary, by using the electric relay module 7 to control the operation time differences of the sample-drawing pump 42, the reagent pump 62, the air pump 22 and the flushing pump 52, this disclosure achieves the automatic drawing of the sample, automatic return of the sample, automatic stop and detection, and automatic flushing. At the same time, the detection between two water samples can be effectively isolated, leading to more accurate automatic detection results. Therefore, the objectives of this disclosure can indeed be achieved.

In the description above, numerous specific details have been set forth for the purposes of explanation in order to provide a thorough understanding of the embodiments. However, it will be apparent to one skilled in the art, that one or more other embodiments may be practiced without some of these specific details. It should also be appreciated that references throughout this specification to “one embodiment,” “an embodiment,” or an embodiment with an indication of an ordinal number,” and so forth, mean that a particular feature, structure, or characteristic may be included in the practice of the disclosure.

It should further be appreciated that, in the description, various features are sometimes grouped together in a single embodiment, figure, or description thereof to streamline the disclosure and aid in the understanding of various inventive aspects. This does not mean that every one of these features needs to be practiced with all the other features. In other words, in any described embodiment, when the implementation of one or more features or specific details does not affect the implementation of another one or more features or specific details, said one or more features may be practiced alone without the other features or specific details.

It should also be noted that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment. Instead, it is intended to cover various arrangements within the spirit and scope of the broadest interpretation, so as to encompass all modifications and equivalent arrangements.

What is claimed is:

1. An automatic analysis device for measuring chemical substances in water, comprising:
a main pipe;
an air push unit including an air pipe and an air pump, said air pipe having one end connected to said main pipe, and another end connected to said air pump, said air pump being configured to draw and push air into said main pipe through said air pipe;
a detection unit including a detector connected to an end of said main pipe opposite said air pipe;
a sample-drawing unit including a sample-drawing pipe, a sample-drawing pump, and a sample water container, said sample-drawing pipe having one end connected to said main pipe, and another end connected to said sample water container, said sample-drawing pipe and said main pipe being positioned between said detector and said air pipe, said sample-drawing pump being connected to said sample-drawing pipe and being configured to draw sample water from said sample water container and push the sample water into said main pipe through said sample-drawing pipe;
a flushing unit including a flushing pipe, a flushing pump, and a flushing liquid container, said flushing pipe having one end connected to said main pipe, and another end connected to said flushing liquid container, said flushing pipe being positioned between said main pipe and said sample-drawing pipe, said flushing pump being connected to said flushing pipe and being configured to draw flushing liquid from said flushing liquid container and push the flushing liquid into said main pipe through said flushing pipe;
a reagent unit including a reagent pipe, a reagent pump, and a reagent container, said reagent pipe having one end connected to said main pipe, and another end connected to said reagent container, said reagent pipe being positioned between said main pipe and said detector, said reagent pump being connected to said reagent pipe and being configured to draw and push a reagent solution from said reagent container into said main pipe through said reagent pipe;
an electric relay module signally communicated to said sample-drawing pump, said reagent pump, said air pump, and said flushing pump; and
a heating unit for heating said main pipe.

2. The automatic analysis device as claimed in claim 1, wherein said electric relay module includes a sample-drawing relay signally communicated to said sample-drawing pump, a reagent relay signally communicated to said reagent pump, an air relay signally communicated to said air pump, a flushing relay signally communicated to said flushing pump, and a main relay signally communicated to said sample-drawing relay, said reagent relay, said air relay, and said flushing relay, and an actuation button signally connected to said main relay.

3. The automatic analysis device as claimed in claim 1, wherein said detection unit further includes a signal transmission module signally communicated to said detector, and a processor communicated to said signal transmission module.

4. A step-flow automatic analysis method for measuring chemical substances in water using the automatic analysis device of claim 1, comprising:
a sample drawing and delivery step, in which the sample-drawing pump and the reagent pump are simultaneously activated through the electric relay module to draw sample water from the sample water container and push the reagent solution from the reagent container through the main pipe to the detection unit for analysis;
a sample return step, in which, before the sample-drawing pump and the reagent pump are stopped at a time denoted as t1, which is equal to or less than two seconds, the air pump is activated to draw and push air into the main pipe, and a flow rate of the air is controlled to match a flow rate of the sample-drawing pump; and in which, after the sample-drawing pump and the reagent pump are turned off at a time denoted as t2, which is equal to or less than two seconds, the air no longer enters the main pipe, but pushes any remaining sample water in the sample-drawing pipe back into the sample water container, after which the air pump is turned off; and a flushing step, in which the flushing pump is activated to allow the flushing liquid to remove the sample water from the main pipe and the detector.

5. The step-flow automatic analysis method as claimed in claim 4, further comprising a stop-and-detection step after the sample return step, in which the sample-drawing pump, the reagent pump, and the air pump are turned off by the electric relay module so as to retain the sample water and the reagent solution in the detector.

6. The step-flow automatic analysis method as claimed in claim 5, wherein the flushing step is performed after the stop-and-detection step, and in the flushing step, the flushing pump is activated by the electric relay module to draw and send the flushing liquid to the main pipe so as to remove the reagent solution and the sample water remaining in the main pipe and the detector.

7. The step-flow automatic analysis method as claimed in claim 5, wherein the detection unit further includes a signal transmission module signally communicated to the detector, and a processor signally communicated to the signal transmission module, and wherein, in the stop-and-detection step, a detection result of the detector is transmitted to the processor through the signal transmission module, and the processor obtains a corresponding detection signal according to the detection result.

8. The step-flow automatic analysis method as claimed in claim 7, wherein the detection signal is obtained based on the detection result and by filtering out bubble noise.

9. The step-flow automatic analysis method as claimed in claim 4, wherein each of the time t1 and the time t2 ranges from 1 to 2 seconds.
